(19) United States
(12) Patent Application Publication
(10) Pub. No.: US 2009/0307573 A1
(43) Pub. Date: Dec. 10, 2009

(54) ENERGY MANAGEMENT SYSTEM

(75) Inventors: Michael R. Lavelle, Indianapolis, IN (US); John M. Duff, Carmel, IN (US)

Correspondence Address: BARNES & THORNBURG LLP, 11 SOUTH MERIDIAN, INDIANAPOLIS, IN, 46204, US

(73) Assignee: ENthEnergy, LLC, Carmel, IN (US)

(21) Appl. No.: 12/479,100

(22) Filed: Jun. 5, 2009

Related U.S. Application Data
(60) Provisional application No. 61/059,394, filed on Jun. 6, 2008.

(51) Int. Cl. G06F 1/28; G06F 3/048; G06F 19/00; G06F 17/30; G06N 5/02; G05D 23/19

(52) U.S. Cl. 715/205; 715/772; 702/62; 700/286; 707/E17.044; 707/104.1; 706/47; 700/276

(57) ABSTRACT

An energy management system and a computer-implemented method of managing energy consumption are disclosed. The computer-implemented method may include receiving one or more input signals which represent the real-time energy consumption of a facility, evaluating data obtained from the one or more input signals according to a set of energy operating rules, and generating output signals which cause a user to be alerted to the energy consumption of the facility. In some embodiments, evaluating data obtained from the one or more input signals according to a set of energy operating rules may include comparing the obtained data to predetermined or adaptive ranges or thresholds. The ranges or thresholds may be based upon at least one of an operational schedule of the facility, physical characteristics of the facility, energy-sensitive variables, customer-imposed targets, and energy supplier demand reduction requests. The system and method may detect anomalous energy use and send an alert message to a user or a browser-enabled user device.

### CROSS REFERENCE TO RELATED APPLICATIONS

This application claims priority under 35 U.S.C. §119(e) to U.S. Provisional Patent Application Ser. No. 61/059,394 entitled “Energy Management System,” filed on Jun. 6, 2008, which is hereby expressly incorporated by reference herein. Cross-reference is made to co-pending U.S. Utility patent application Ser. No. ______ entitled “Energy Information Management System” by John M. Duff and Michael R. Lavelle (Attorney Docket No. 37246-208886), which is assigned to the same assignee as the present application, filed concurrently herewith, and hereby expressly incorporated by reference herein.

### BACKGROUND OF THE INVENTION

The present disclosure generally relates to the management of energy consumption. More particularly, the present disclosure relates to energy management systems and computer-implemented methods of managing energy consumption.

### SUMMARY OF THE INVENTION

The present application discloses one or more of the features recited in the appended claims and/or the following features which, alone or in any combination, may comprise patentable subject matter:

According to one aspect, a computer-implemented method of managing the energy consumption of a facility comprises receiving one or more input signals which represent the real-time energy consumption of the facility, evaluating data obtained from the one or more input signals according to a set of energy operating rules, and generating output signals which cause a user to be alerted to the energy consumption of the facility. In some embodiments, the one or more input signals which represent the real-time energy consumption of the facility may be received at least every fifteen minutes. In still other embodiments, the one or more input signals may be received at least every one minute. The one or more input signals which represent the real-time energy consumption of the facility may include energy meter interval operating data. The one or more input signals may also include heating, ventilation, and air conditioning (HVAC) equipment status data. In some embodiments, the one or more input signals may further include local weather conditions data.

In some embodiments of the method of managing energy consumption, evaluating data obtained from the one or more input signals according to a set of energy operating rules may include comparing the obtained data to predetermined ranges or thresholds. The predetermined ranges or thresholds may be based upon at least one of an operational schedule of the facility, physical characteristics of the facility, energy-sensitive variables, customer-imposed targets, and energy supplier demand reduction requests. In other embodiments, the method may also include storing data obtained from the one or more input signals to provide a database of historic energy consumption data. In such embodiments, evaluating data obtained from the one or more input signals according to a set of energy operating rules may include comparing the obtained data to adaptive ranges or thresholds. The adaptive ranges or thresholds may be based at least in part upon the stored historic energy consumption data. The adaptive ranges or thresholds may also be based upon at least one of an operational schedule of the facility, physical characteristics of the facility, energy-sensitive variables, customer-imposed targets, and energy supplier demand reduction requests.

In still other embodiments, the method of managing energy consumption may include generating output signals which cause a graphical representation of the real-time energy consumption of the facility over a rolling period of time to be displayed to a user. The graphical representation of the real-time energy consumption of the facility may include one or more graphs showing energy consumption and local temperature as a function of time over a plurality of days. In some embodiments, the method includes detecting anomalous energy use and sending an alert message to a user containing a description of the anomalous energy use. The alert message may further include a hyperlink which the user may select to display a graphical representation of the real-time energy consumption of the facility.

According to another aspect, a computer-readable medium may embody a program of instructions executable by a processor to perform process steps for managing energy information. This program of instructions, executable by the processor, may comprise receiving one or more input signals which represent the real-time energy consumption of a facility, evaluating data obtained from the one or more input signals according to a set of energy operating rules, and generating output signals which cause a user to be alerted to the energy consumption of the facility. In some embodiments, the one or more input signals which represent the real-time energy consumption of the facility may be received at least every fifteen minutes. In still other embodiments, the one or more input signals may be received at least every one minute. The one or more input signals which represent the real-time energy consumption of the facility may include energy meter interval operating data. The one or more input signals may also include heating, ventilation, and air conditioning (HVAC) equipment status data. In some embodiments, the one or more input signals may further include local weather conditions data.

In some embodiments of the computer-readable medium, evaluating data obtained from the one or more input signals according to a set of energy operating rules may include comparing the obtained data to predetermined ranges or thresholds. The predetermined ranges or thresholds may be based upon at least one of an operational schedule of the facility, physical characteristics of the facility, energy-sensitive variables, customer-imposed targets, and energy supplier demand reduction requests. In other embodiments, the program of instructions may also include storing data obtained from the one or more input signals to provide a database of historic energy consumption data. In such embodiments, evaluating data obtained from the one or more input signals according to a set of energy operating rules may include comparing the obtained data to adaptive ranges or thresholds. The adaptive ranges or thresholds may be based at least in part upon the stored historic energy consumption data. The adaptive ranges or thresholds may also be based upon at least one of an operational schedule of the facility, physical characteristics of the facility, energy-sensitive variables, customer-imposed targets, and energy supplier demand reduction requests.

In still other embodiments, the program of instructions may include generating output signals which cause a graphical representation of the real-time energy consumption of the facility over a rolling period of time to be displayed to a user. The graphical representation of the real-time energy consumption of the facility may include one or more graphs showing energy consumption and local temperature as a function of time over a plurality of days. In some embodiments, the program of instructions includes detecting anomalous energy use and sending an alert message to a user containing a description of the anomalous energy use. The alert message further may include a hyperlink which the user may select to display a graphical representation of the real-time energy consumption of the facility.

According to yet another aspect, an energy management system may comprise one or more sources which generate input signals based upon the real-time energy consumption of a facility, a browser-enabled user device, and a server which is configured to: (i) receive the input signals from the one or more sources, (ii) evaluate data obtained from the input signals according to a set of energy operating rules, and (iii) generate output signals which cause information regarding the energy consumption of the facility to be transmitted to the user device. In some embodiments, at least one of the sources generates an input signal at least every fifteen minutes. In other embodiments, at least one of the sources generates an input signal at least every one minute. The one or more sources may include a utility meter or shadow meter which continuously measures the power consumption of a facility. The one or more sources may also include a sensor or utility sub-meter which continuously measures the status of a unit of heating, ventilation, and air conditioning (HVAC) equipment. The energy management system may further include a data source which generates input signals based upon local weather conditions.

In some embodiments, the server of the energy management system may be configured to compare the obtained data to predetermined ranges or thresholds. The predetermined ranges or thresholds may be based upon at least one of an operational schedule of the facility, physical characteristics of the facility, energy-sensitive variables, customer-imposed targets, and energy supplier demand reduction requests. In some embodiments, the server of the energy management system may be further configured to store data obtained from the input signals to provide a database of historic energy consumption data. In such embodiments, the server may be configured to compare the obtained data to adaptive ranges or thresholds. The adaptive ranges or thresholds being based at least in part upon the stored historic energy consumption data. The adaptive ranges or thresholds may also be based upon at least one of an operational schedule of the facility, physical characteristics of the facility, energy-sensitive variables, customer-imposed targets, and energy supplier demand reduction requests.

In still other embodiments, the server of the energy management system may be configured to generate output signals which cause a graphical representation of the real-time energy consumption of the facility over a rolling period of time to be displayed on the browser-enabled user device. The graphical representation of the real-time energy consumption of the facility may include one or more graphs showing energy consumption and local temperature as a function of time over a plurality of days. In some embodiments, the server may be configured to detect anomalous energy use and transmit an alert message to the browser-enabled user device containing a description of the anomalous energy use. The alert message may include a hyperlink which the user may select to display a graphical representation of the real-time energy consumption of the facility on the browser-enabled user device. The browser-enabled user device may be a personal computer, remote from the server, or a wireless device.

Additional features, which alone or in combination with any other feature(s), including those listed above and those listed in the claims, may comprise patentable subject matter and will become apparent to those skilled in the art upon consideration of the following detailed description of illustrative embodiments exemplifying the best mode of carrying out the invention as presently perceived.

### BRIEF DESCRIPTION OF THE DRAWINGS

The invention described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. The detailed description particularly refers to the accompanying figures in which:

FIG. 1 illustrates an embodiment of an energy management system (EMS); and

FIG. 2 illustrates an embodiment of a graphical representation of the real-time energy consumption of a facility, which is generated by the EMS.

### DETAILED DESCRIPTION OF THE DRAWINGS

In the following detailed description, numerous specific details are described in order to provide a thorough understanding of the invention. Building energy consumption can be changed through the use of computer software processes 101 designed to monitor building real-time and historical operating conditions, current and historical weather, and building mechanical and electrical equipment operation. By use of the term “real-time,” this disclosure generally refers to methods or systems which generate, receive, collect, process, evaluate, and/or display data or information on a more frequent basis than once per day. For instance, a real-time system might update its information approximately every one hour, fifteen minutes, one minute, or five seconds.

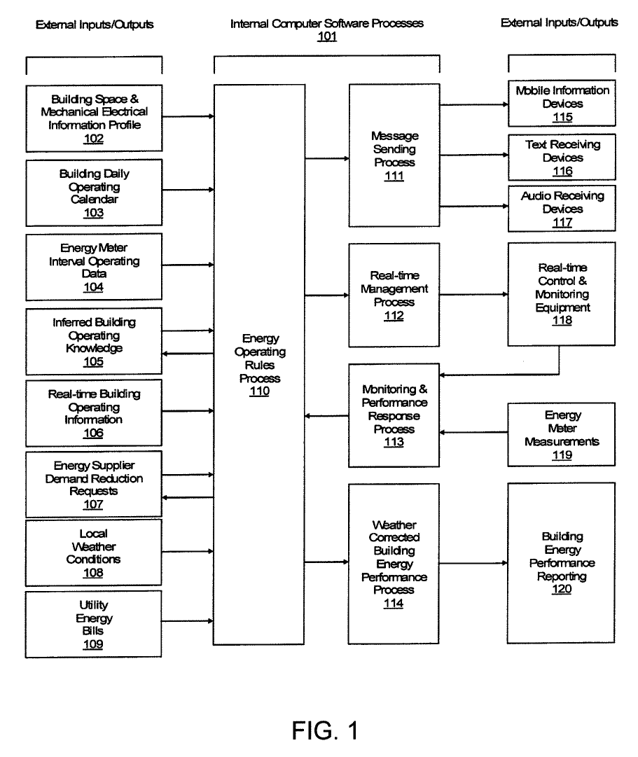

The operation of these computer software processes 101 uses custom-designed if-then-else rules, as well as inferred rules derived from current and historical operating information from multiple buildings. As illustrated in FIG. 1, energy operating rules 110 communicate with mobile information devices 115, text receiving devices 116, and audio receiving devices 117 through a message sending process 111. The energy operating rules process 110 is also capable of sending instructions to real-time building control and monitoring equipment 118 through a real-time management process 112 which formats control instructions suitable for delivery to the real-time control and monitoring equipment 118. Actual building energy performance is evaluated by a monitoring and performance response process 113, which uses realtime control and monitoring equipment 118 data as well as energy meter measurements 119. Building energy performance reporting 120 is provided by the weather corrected building energy performance process 114, which derives its data from the energy operating rules process 110 and other information sources.

The energy operating rules 110 interact with several external inputs and outputs, as shown in FIG. 1. One example is building space and mechanical information profile 102, which is a collection of computer tables capable of storing data that can be used in processing the energy operating rules 110. The table information includes, for example, building physical characteristics such as size, construction type, heating and air conditioning system type, lighting type, and temperature control system operating methods. The energy operating rules 110 may also interact with a building daily operating calendar 103, which is a repository of daily building events that affect the operation of energy consuming equipment such as, for example, boilers, chillers, package air conditioning, fans, domestic hot water and food preparation. Calendar events are periodically read by the energy operating rules process 110 along with other input information to determine if an output action is required. Furthermore, building energy usage can be monitored in small time increments to gather energy meter interval operating data 104. Interval data is supplied in discrete time increments, usually ranging from one to fifteen minutes. In some embodiments, this energy meter interval operating data 104 is supplied in smaller increments, such as five seconds. The data represents the energy used in that time period and acts as an information source to the energy operating rules process 110.

Buildings exhibit common operating traits that are captured within the inferred building operating knowledge 105 information repository, which can be utilized by energy operating rules process 10. Inputs include, for example, energy consumption rates, weather conditions, equipment runtime operation, space temperatures, humidity, operating schedules, occupancy rates, type of heating and air conditioning systems, and the methods of controlling such equipment. This information is used to train the inferred building operating knowledge 105 process such that subsequent queries are capable of recommending operating methods such as, for example, heating and air conditioning equipment temperature control parameter values. In addition, this process 105 is trained to recognize operating problems and is capable of producing suggested improvements to the building operating methods.

In properly equipped buildings, real-time monitoring systems 106 are read by the energy operating rules process 110 as part of the building evaluation. Real-time data can be delivered to a file or provided directly to the energy operating rules process 110 using computer input-output techniques such as shared and named pipes or XML data streams. Data can include, for example, space and equipment temperatures and humidity, motor and variable frequency drive electricity consumption, boiler burner fossil fuel usage, pump and valve flow rates, operating pressures, and cooling equipment runtime parameters.

In some cases, the availability of energy for building consumption may be regulated through utility tariffs and intermediate government or other regulatory agencies. The building energy operation rules process 110 is capable of receiving energy supplier demand reduction requests 107 which can trigger a reduction in energy use for either an extended or temporary time period. These requests can include, for example, a confirmation of reduced energy usage that is delivered back to the utility or agency. Confirmation information is provided by the energy operating rules process 110 using input information from real-time control and monitoring equipment 118 and energy meter measurements 119.

Weather is also known to affect building energy consumption and may be gathered from national and local weather information sources through the local weather conditions 108 process. Illustrative collection methods include, for example, readings from the National Weather Service, commercial weather collection companies, local building outside air temperatures and humidity using real-time control and monitoring equipment 118, and specialized weather evaluation equipment.

Building energy usage is ultimately validated by information provided by a utility invoice which is read and evaluated using the utility energy bills 109 process. Utility billing information includes, for example, usage during a known time period, peak demand during that time period, and the cost of energy delivered to the building. Utility billing information can be delivered, for example, through paper invoices, spreadsheet files, comma delimited text files, and streaming XML data. Billing information is made available to the energy operating rules process 110 as part of the evaluation process including, for example, the inferred building operating knowledge 105 process to assist in predicting future energy usage and cost.

Using the information described above, the energy operating rules process 110 is capable of accepting multiple inputs of data from various sources such as, for example, computer files, computer streamed data, building real-time data, and utility meter information. The data is then evaluated in accordance with pre-programmed instructions using an if-then-else decision-tree process. The pre-programmed instructions are derived from observed building operating characteristics based on the experience of experts in energy and building operations. By way of example, the energy operating rules process 110 may compare the data to predetermined ranges or thresholds which are based upon at least one of an operational schedule of the facility, physical characteristics of the facility, energy-sensitive variables, customer-imposed targets, and energy supplier demand reduction requests. The process 110 is capable of simultaneously reading and writing data with multiple data sources and delivering building-specific instructions to mobile information devices 115, text receiving devices 116, audio receiving devices 117, real-time control and monitoring equipment 118, and building energy performance reporting 120. The process 110 can be composed of, for example, a series of separate computer tasks designed to sub-divide the evaluation work. The computer tasks in this process 110 may run on one or more computers which may be located throughout the world and connected together by the Internet, using well-known methods such as socket-to-socket TCP/IP.

Instructions and information from the energy operating rules process 110 is delivered to a message sending process 111 for appropriate formatting and connection to public information delivery services including, for example, mobile communications provided by wireless cellular and wireless fidelity (WiFi) companies, landline (POTS) companies, and text information services such as Internet messaging (IM), email, and short messaging services (SMS). The message sending process 111 provides information for delivery to recipients who participate in the building energy reduction and management program using contact information included in the building space and mechanical electrical information profile 102. These messages may also contain hyperlinks which allow the recipient to retrieve further information from the energy management system. Delivered messages from the process 111 are designed to support a building energy information program where occupants, technicians, and building management participate in an information gathering process for reducing energy usage. This process, called energy awareness, uses educational and informational methods to assist and direct building occupants and operating staff along with temperature control instructions capable of reducing energy usage on a continuing and sustainable basis.

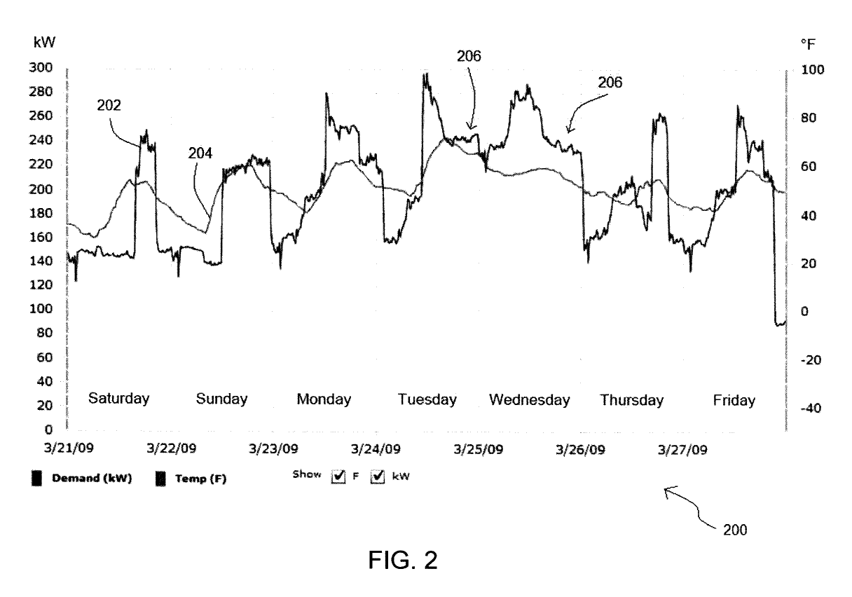

An illustrative example of information generated by the software processes 101 of the energy management system is shown in FIG. 2. Among other formats, the energy management system can cause a graphical representation 200 of the real-time energy consumption of the facility over a rolling period of time to be displayed on a browser-enabled user device. In FIG. 2, this rolling period of time is illustrated as a one week period. The graphical representation 200 may include one or more graphs showing energy consumption 202 and local temperature 204 as a function of time. In some embodiments, the energy management system may be configured to detect anomalous energy use 206 (e.g., high energy consumption during off-peak hours) and transmit an alert message to the browser-enabled user device containing a description of the anomalous energy use.

Referring once more to FIG. 1, building operating variable values and control instructions are determined by the real-time management process 112. This process accepts information from the energy operating rules process 110 and applies building operating constraints, derived from, for example, the building space and mechanical electrical information profile 102 and the building daily operating calendar 103, and delivers appropriately formatted instructions to the building real-time control and monitoring equipment 118. Control instructions, for example, can include equipment on-off commands, variable speed drive operating control (PID) setpoint commands, and chiller demand limiter setpoint commands. These commands use information gathered from the building space and mechanical electrical information profile 102 to assist in making decisions about the magnitude of a variable and timing associated with a change in operating methods.

Building real-time operating information is delivered by the monitoring and performance response process 113 to the energy operating rules process 110. This process 110 selects the appropriate real-time information from the real-time control and monitoring equipment 118 and formats the data for reading by the energy operating rules process 110. This process 110 uses the supplied real-time data as part of the if-then-else decision making routine. Monitoring and performance response process 113 also supplies a sub-set of this data to the inferred building operating knowledge 105 process in support of training this process 105 to better analyze building performance and recognize operating problems. The process 113 also reads energy operating data from the energy meter measurements 119 information source to assist in evaluating building energy performance. Energy meter measurements 119 can be read from on-site meter equipment, for example, or from collected meter information supplied by a third party. Meter data can be read in short intervals (e.g., fifteen minutes or less), daily, or monthly, as required for evaluation by the monitoring and performance response process 113.

The energy operating rules process 110 is capable of supplying information to the weather corrected building energy performance process 114. This information is appropriately formatted and delivered as building energy performance reporting 120 in text and graphical form for viewing on an electronic display or as printed document. This process 114 uses information from local weather conditions 108 which can include, for example, short term hourly as well as long-term historical weather data. The weather corrected building energy performance process 114 uses regression and similar mathematical techniques to provide a weather-corrected base year of energy operating information. The resulting output from 114 is a report that properly accounts for weather variations over the evaluation period and permits building energy usage to be appropriately compared from month to month and year to year. In some embodiments, the building energy performance reporting 120 output may have a similar format to the graphical representation 200 shown in FIG. 2.

Although certain illustrative embodiments have been described in detail above, variations and modifications exist within the scope and spirit of this disclosure as described and as defined in the following claims.

1. A computer-implemented method of managing the energy consumption of a facility, the method comprising:
receiving one or more input signals which represent the real-time energy consumption of a facility;
evaluating data obtained from the one or more input signals according to a set of energy operating rules; and
generating output signals which cause a user to be alerted to the energy consumption of the facility.

2. The method of claim 1, wherein the one or more input signals which represent the real-time energy consumption of the facility are received at least every fifteen minutes.

3. The method of claim 1, wherein the one or more input signals which represent the real-time energy consumption of the facility are received at least every one minute.

4. The method of claim 1, wherein the one or more input signals which represent the real-time energy consumption of the facility comprise energy meter interval operating data.

5. The method of claim 1, wherein the one or more input signals which represent the real-time energy consumption of a facility comprise heating, ventilation, and air conditioning (HVAC) equipment status data.

6. The method of claim 1, wherein the one or more input signals which represent the real-time energy consumption of a facility further comprise local weather conditions data.

7. The method of claim 1, wherein evaluating data obtained from the one or more input signals according to a set of energy operating rules comprises comparing the obtained data to predetermined ranges or thresholds.

8. The method of claim 7, wherein the predetermined ranges or thresholds are based upon at least one of an operational schedule of the facility, physical characteristics of the facility, energy-sensitive variables, customer-imposed targets, and energy supplier demand reduction requests.

9. The method of claim 1, further comprising storing data obtained from the one or more input signals to provide a database of historic energy consumption data.

10. The method of claim 9, wherein evaluating data obtained from the one or more input signals according to a set of energy operating rules comprises comparing the obtained data to adaptive ranges or thresholds, the adaptive ranges or thresholds being based at least in part upon the stored historic energy consumption data.

11. The method of claim 10, wherein the adaptive ranges or thresholds are also based upon at least one of an operational schedule of the facility, physical characteristics of the facility, energy-sensitive variables, customer-imposed targets, and energy supplier demand reduction requests.

12. The method of claim 1, wherein generating output signals which cause a user to be alerted to the energy consumption of the facility comprises generating output signals which cause a graphical representation of the real-time energy consumption of the facility over a rolling period of time to be displayed to a user.

13. The method of claim 12, wherein the graphical representation of the real-time energy consumption of the facility comprises one or more graphs showing energy consumption and local temperature as a function of time over a plurality of days.

14. The method of claim 1, wherein:
evaluating data obtained from the one or more input signals according to a set of energy operating rules comprises detecting anomalous energy use; and
generating output signals which cause a user to be alerted to the energy consumption of the facility comprises sending an alert message to a user containing a description of the anomalous energy use.

15. The method of claim 14, wherein the alert message further comprises a hyperlink which the user may select to display a graphical representation of the real-time energy consumption of the facility.

16. A computer-readable medium embodying a program of instructions executable by a processor to perform process steps for managing energy information, said process steps comprising:
receiving one or more input signals which represent the real-time energy consumption of a facility;
evaluating data obtained from the one or more input signals according to a set of energy operating rules; and
generating output signals which cause a user to be alerted to the energy consumption of the facility.

17. The computer-readable medium of claim 16, wherein the one or more input signals which represent the real-time energy consumption of the facility are received at least every fifteen minutes.

18. The computer-readable medium of claim 16, wherein the one or more input signals which represent the real-time energy consumption of the facility are received at least every one minute.

19. The computer-readable medium of claim 16, wherein the one or more input signals which represent the real-time energy consumption of the facility comprise energy meter interval operating data.

20. The computer-readable medium of claim 16, wherein the one or more input signals which represent the real-time energy consumption of a facility comprise heating, ventilation, and air conditioning (HVAC) equipment status data.

21. The computer-readable medium of claim 16, wherein the one or more input signals which represent the real-time energy consumption of a facility further comprise local weather conditions data.

22. The computer-readable medium of claim 16, wherein evaluating data obtained from the one or more input signals according to a set of energy operating rules comprises comparing the obtained data to predetermined ranges or thresholds.

23. The computer-readable medium of claim 22, wherein the predetermined ranges or thresholds are based upon at least one of an operational schedule of the facility, physical characteristics of the facility, energy-sensitive variables, customer-imposed targets, and energy supplier demand reduction requests.

24. The computer-readable medium of claim 16, further comprising instructions executable by the processor to perform the process step of storing data obtained from the one or more input signals to provide a database of historic energy consumption data.

25. The computer-readable medium of claim 24, wherein evaluating data obtained from the one or more input signals according to a set of energy operating rules comprises comparing the obtained data to adaptive ranges or thresholds, the adaptive ranges or thresholds being based at least in part upon the stored historic energy consumption data.

26. The computer-readable medium of claim 25, wherein the adaptive ranges or thresholds are also based upon at least one of an operational schedule of the facility, physical characteristics of the facility, energy-sensitive variables, customer-imposed targets, and energy supplier demand reduction requests.

27. The computer-readable medium of claim 16, wherein generating output signals which cause a user to be alerted to the energy consumption of the facility comprises generating output signals which cause a graphical representation of the real-time energy consumption of the facility over a rolling period of time to be displayed to a user.

28. The computer-readable medium of claim 27, wherein the graphical representation of the real-time energy consumption of the facility comprises one or more graphs showing energy consumption and local temperature as a function of time over a plurality of days.

29. The computer-readable medium of claim 16, wherein:
evaluating data obtained from the one or more input signals according to a set of energy operating rules comprises detecting anomalous energy use; and
generating output signals which cause a user to be alerted to the energy consumption of the facility comprises sending an alert message to a user containing a description of the anomalous energy use.

30. The computer-readable medium of claim 29, wherein the alert message further comprises a hyperlink which the user may select to display a graphical representation of the real-time energy consumption of the facility.

31. An energy management system, the system comprising:
one or more sources which generate input signals based upon the real-time energy consumption of a facility;
a browser-enabled user device; and
a server which is configured to: (i) receive the input signals from the one or more sources, (ii) evaluate data obtained from the input signals according to a set of energy operating rules, and (iii) generate output signals which cause information regarding the energy consumption of the facility to be transmitted to the user device.

32. The energy management system of claim 31, wherein at least one of the sources generates an input signal at least every fifteen minutes.

33. The energy management system of claim 31, wherein at least one of the sources generates an input signal at least every one minute.

34. The energy management system of claim 31, wherein at least one of the sources comprises a utility meter or shadow meter which continuously measures the power consumption of a facility.

35. The energy management system of claim 31, wherein at least one of the sources comprises a sensor or utility sub-meter which continuously measures the status of a unit of heating, ventilation, and air conditioning (HVAC) equipment.

36. The energy management system of claim 31, further comprising a data source which generates input signals based upon local weather conditions.

37. The energy management system of claim 31, wherein the server is configured to compare the obtained data to predetermined ranges or thresholds.

38. The energy management system of claim 37, wherein the predetermined ranges or thresholds are based upon at least one of an operational schedule of the facility, physical characteristics of the facility, energy-sensitive variables, customer-imposed targets, and energy supplier demand reduction requests.

39. The energy management system of claim 31, wherein the server is further configured to store data obtained from the input signals to provide a database of historic energy consumption data.

40. The energy management system of claim 39, wherein the server is configured to compare the obtained data to adaptive ranges or thresholds, the adaptive ranges or thresholds being based at least in part upon the stored historic energy consumption data.

41. The energy management system of claim 40, wherein the adaptive ranges or thresholds are also based upon at least one of an operational schedule of the facility, physical characteristics of the facility, energy-sensitive variables, customer-imposed targets, and energy supplier demand reduction requests.

42. The energy management system of claim 31, wherein the server is configured to generate output signals which cause a graphical representation of the real-time energy consumption of the facility over a rolling period of time to be displayed on the browser-enabled user device.

43. The energy management system of claim 42, wherein the graphical representation of the real-time energy consumption of the facility comprises one or more graphs showing energy consumption and local temperature as a function of time over a plurality of days.

44. The method of claim 31, wherein the server is configured to detect anomalous energy use and transmit an alert message to the browser-enabled user device containing a description of the anomalous energy use.

45. The method of claim 44, wherein the alert message further comprises a hyperlink which the user may select to display a graphical representation of the real-time energy consumption of the facility on the browser-enabled user device.

46. The energy management system of claim 31, wherein the browser-enabled user device comprises a personal computer, remote from the server.

47. The energy management system of claim 31, wherein the browser-enabled user device comprises a wireless device.
